(19) United States
(12) Patent Application Publication
(10) Pub. No.: US 2011/0236649 A1
(43) Pub. Date: Sep. 29, 2011

(54) INK COMPOSITION, INK JET RECORDING METHOD, AND RECORDED MATTER

(75) Inventors: Ayako NISHIKI, Matsumoto-shi (JP); Chei Maruyama, Matsumoto-shi (JP); Miharu Kanaya, Azamino-shi (JP); Soichi Yamazaki, Shiojiyi-shi (JP)

(73) Assignee: SEIKO EPSON CORPORATION

(21) Appl. No.: 13/071,617

(22) Filed: Mar. 25, 2011

(30) Foreign Application Priority Data
Mar. 26, 2010 (JP) 2010-072403

(51) Int. Cl. C09D 11/10; B32B 3/10; B05D 5/00

(52) U.S. Cl. 428/195.1; 524/555; 427/256

(57) ABSTRACT

An ink composition includes at least a pigment, a polyhydric alcohol monoalkyl ether having a vapor pressure of 0.1 mmHg or less at 20° C. and/or a nitrogen-containing cyclic compound, a polyhydric alcohol, an unsaturated fatty acid, an alkyl alcohol having 1 to 4 carbon atoms, a surfactant, and 10% to 60% by mass of water. An in jet recording method uses the ink composition, and a recorded matter is produced by the ink jet recording method.

### BACKGROUND

1. Technical Field

The present invention relates to an ink composition, an ink jet recording method, and a recorded matter. More specifically, the present invention relates to an ink composition excellent in ejection characteristics, an ink jet recording method, and a recorded matter.

2. Related Art

An ink jet recording method is a printing method of printing by allowing ink droplets to fly from a printer head and landing the ink droplets on a recording medium such as paper or the like. Inks used in the ink jet recording method preferably have low viscosity because the inks are allowed to fly from a printer head, and generally contain water as a main component and a coloring agent and a wetting agent such as glycerin or the like for preventing clogging and the like. As the coloring agent, dyes are used in view of excellent color development and stability. However, images formed using dye-based inks are practically insufficient in light resistance, water resistance, and the like. Although water resistance is improved to some extent by improving ink jet-exclusive recording paper having an ink absorbing layer, water resistance of plain paper is unsatisfactory.

In recent years, in order to improve the above-described problem, pigment-based inks using, in place of dyes, pigments such as organic pigments, carbon black, and the like as coloring agents have been investigated. Since pigments are insoluble in water, pigments are mixed with dispersants and stably dispersed in water by dispersion treatment to form aqueous inks. In many cases, water resistance and light resistance are improved by using pigments as compared with use of dyes. However, in high-speed printing on plain paper, it is difficult to achieve high image density and color development with general pigment inks, and character blurring, color boundary blurring, and double-side printability are not fully satisfied.

In addition, plain paper and coated paper are lack of water absorbency, and thus printing on coated paper with usual ink compositions has the problem of causing phenomena such as so-called “cockling” in which wavy wrinkles occur in the paper after inks are ejected, so-called “curling” in which the paper is curled, and the like. In recent years, pigment inks having a high solid content and a low moisture content have been proposed for resolving the problems (Japanese Unexamined Patent Application Publication No. 2008-266598).

On the other hand, in ink jet recording, an ink jet recording head is required to stably eject ink droplets from micro nozzles, and thus it is necessary to prevent the occurrence of ink solidification or the like due to drying of orifices of the ink jet recording head. However, inks using pigments may cause clogging, non-ejection of inks, or the like due to undissolution of solid contents such as pigments after adhering to the orifices or the like. In particular, when printing is halted for a long time, clogging in the nozzles or the like easily occurs, and an thickened ink may be accumulated in a maintenance mechanism in a nozzle cap, a suction tube, or the like, thereby deteriorating the function of the maintenance mechanism. In addition, even when printing is halted or when printing is halted for nozzles corresponding to a blank during printing of a document or image having a blank, the problem of printing error (intermittent ejection error) or the like occurs due to disturbance of an ejection direction of ink droplets. Aqueous pigment inks are viscous and thus have the problem of causing resistance in a path toward a nozzle tip during long-term continuous ejection and high-speed printing, thereby causing unstable ejection and difficulty in smooth recording.

In particular, the above-described pigment-based inks having a low moisture content have the problem of degrading the ejection stability due to the higher solid content of pigments or the like than general pigment-based inks.

### SUMMARY

An advantage of some aspects of the invention is that the invention provides a technique capable of realizing excellent curl and cockling properties and high color development for media having low water absorbency, such as plain paper, coated paper, and the like, and capable of improving ejection stability of pigment-based inks with a high solid content.

An ink composition according to an embodiment of the present invention includes at least a pigment, a polyhydric alcohol monoalkyl ether having a vapor pressure of 0.1 mmHg or less at 20° C. and/or a nitrogen-containing cyclic compound, a polyhydric alcohol, an unsaturated fatty acid, an alkyl alcohol having 1 to 4 carbon atoms, a surfactant, and 10% to 60% by mass of water.

In the ink composition, the content of the unsaturated fatty acid is preferably 0.08% to 3% by mass.

In the ink composition, the unsaturated fatty acid is preferably oleic acid.

In the ink composition, the content of the pigment is preferably 6% by mass or more.

In the ink composition, the pigment is coated with a water-insoluble polymer.

In the ink composition, the pigment is a self-dispersible pigment.

In the ink composition, the surfactant is an acethylene glycol surfactant and/or a poly-modified siloxane surfactant.

The ink composition further includes a resin emulsion.

In the ink composition, the resin emulsion is a mixture of resin fine particles having a minimum film-forming temperature of 20° C. or more and resin fine particles having a minimum film-forming temperature of less than 20° C.

An ink jet recording method according to an embodiment of the present invention includes printing by ejecting droplets of an ink composition and adhering the droplets to a recording medium, wherein the ink composition according to an embodiment of the present invention is used.

A recorded matter recorded by the ink jet recording method according to an embodiment of the present invention.

### DESCRIPTION OF EXEMPLARY EMBODIMENTS

### Ink Composition

An ink composition according to an embodiment of the present invention includes at least a pigment, a polyhydric alcohol monoalkyl ether having a vapor pressure of 0.1 mmHg or less at 20° C. and/or a nitrogen-containing cyclic compound, a polyhydric alcohol, an unsaturated fatty acid, an alkyl alcohol having 1 to 4 carbon atoms, a surfactant, and 10% to 60% by mass of water.

In view of light resistance, a pigment is used as a coloring agent of the ink composition used in the present invention. As the pigment, any one of an inorganic pigment and an organic pigment may be used.

Examples of the inorganic pigment include carbon blacks (C. I. Pigment Black 7) such as furnace black, lamp black, acetylene black, channel black, and the like; iron oxide; titanium oxide; zinc oxide; zirconium oxide; ultramarine blue; iron blue; chromium oxide; and the like.

Examples of the organic pigment include azo pigments such as insoluble azo pigments, condensed azo pigments, azo lake, chelate azo pigments, and the like; polycyclic pigments such as phthalocyanine pigments, perylene and perinone pigments, anthraquinone pigments, quinacridone pigments, dioxane pigments, thioindigo pigments, isoindolinone pigments, quinophthalone pigments, and the like; dye chelates (for example, a basic dye-type chelate, an acid dye-type chelate, and the like); dye lakes (basic dye-type lake and acid dye-type lake); nitro pigments, nitroso pigments, aniline black, daylight fluorescent pigments; and the like. These pigments can be used alone or in combination of two or more.

The ink composition of the present invention is used as a black ink composition, a color ink composition, or the like.

As a pigment used in the black ink composition, carbon black is preferred. Specific examples of carbon black include #2300, #900, HCF88, #33, #40, #45, #52, MA7, MA8, MA100, #2200B, and the like which are manufactured by Mitsubishi Chemical Corporation; Raven 5750, 5250, 5000, 3500, 1255, 700, and the like which are manufactured by Columbia Chemical Co.; Regal 400, 330R, and 660R, Mogul L and 700, Monarch 800, 880, 900, 1000, 1100, 1300, 1400, and the like which are manufactured by Cabot Corporation; Color Black FW1, FW2V, FW18, and FW200, Color Black S150, 5160, and S170, Printex 35, U, V, and 140U, Special Black 6, 5, 4A, and 4 which are manufactured by Degussa Corporation. These may be used alone or as a mixture of two.

The color ink composition is used as a yellow ink composition, a magenta ink composition, a cyan ink composition, or the like, and is preferably used as an ink set containing at least a yellow ink composition, a magenta ink composition, and a cyan ink composition. Examples of a pigment of the color ink composition include pigments described in Color Index, such as pigment yellow, pigment red, pigment violet, pigment blue, and the like.

Specific examples include C. I. Pigment Yellow 1, 3, 12, 13, 14, 17, 24, 34, 35, 37, 42, 53, 55, 74, 81, 83, 95, 97, 98, 100, 101, 104, 108, 109, 110, 117, 120, 128, 138, 147, 150, 153, 155, 174, 180, 188, and 198; C. I. Pigment Red 1, 3, 5, 8, 9, 16, 17, 19, 22, 38, 57:1, 90, 112, 122, 123, 127, 146, 184, 202, 207, and 209; C. I. Pigment Violet 1, 3, 5:1, 16, 19, 23, and 38; C. I. Pigment Blue 1, 2, 15, 15:1, 15:2, 15:3, 15:4, and 16; C. I. Pigment Black 1 and 7; and the like. The ink composition may be formed using a plurality of pigments.

In particular, preferably, an organic pigment contained in the yellow ink composition contains at least one selected from C. I. Pigment Yellow 74, 109, 110, 128, 138, 147, 150, 155, 180, and 183; an organic pigment contained in the magenta ink composition contains at least one selected from C. I. Pigment Red 122, 202, 207, and 209, and C. I. Pigment Violet 19; and an organic pigment contained in the cyan ink composition contains at least one selected from C. I. Pigment Blue 15, 15:1, 15:2, 15:3, 15:4, and 16.

In addition, any pigment not described in Color Index may be used as long as it is insoluble in water.

In the ink composition of the present invention, a pigment coated with a water-insoluble polymer can be used. As the pigment, any one of the above-described coloring agents and known inorganic pigments and organic pigments can be used.

The “water-insoluble polymer” represents a polymer composed of a block copolymer resin of a hydrophobic group-containing monomer and a hydrophilic group-containing monomer, containing at least a salt-forming group, and having a solubility of less than 1 g for 100 g of water at 25° C. after neutralization.

Examples of the hydrophobic group-containing monomer include methacrylates such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, glycidyl methacrylate, and the like; vinyl esters such as vinyl acetate and the like; vinylcyan compounds such as acrylonitrile, methacrylonitrile, and the like; aromatic vinyl monomers such as styrene, α-methylstyrene, vinyltoluene, 4-tert-butylstyrene, chlorostyrene, vinylanisole, vinylnaphthalene, and the like. These may be used alone or as a mixture of two or more.

Examples of the hydrophilic group-containing monomer include polyethylene glycol monomethacrylate, polypropylene glycol monomethacrylate, ethylene glycol-propylene glycol monomethacrylate, and the like. These may be used alone or as a mixture of two or more. In particular, by using a monomer component which constitutes a branched chain, such as polyethylene glycol (2-30) monomethacrylate, polyethylene glycol (1-15)-propylene glycol (1-15) monomethacrylate, polypropylene glycol (2-30) methacrylate, methoxypolyethylene glycol (2-30) methacrylate, methoxypolytetramethylene glycol (2-30) methacrylate, methoxy(ethylene glycol-propylene glycol copolymer) (1-30) Methacrylate, or the like, glossiness of a printed image is improved.

Examples of the monomer having a salt-forming group include acrylic acid, methacrylic acid, styrenecarboxylic acid, maleic acid, and the like. These monomers can be used alone or as a mixture of two or more.

Further, a macromonomer such as a styrene macromonomer, a silicone macromonomer, or the lie, or another monomer may be combined.

The water-insoluble polymer is produced by copolymerizing monomers according to a known polymerization method such as a bulk polymerization method, a solution polymerization method, a suspension polymerization method, an emulsion polymerization method, or the like, but the solution polymerization method is particularly preferred. During polymerization, a known radical polymerization agent and polymerization chain transfer agent may be added.

The pigment coated with the water-insoluble polymer can be produced by, for example, dissolving the above-described water-insoluble polymer in an organic solvent such as methanol, ethanol, isopropanol, n-butanol, acetone, methyl ethyl ketone, dibutyl ether, or the like, adding the pigment to the resultant solution, then adding a neutralizing agent and water and kneading and dispersing the mixture to prepare an oil-in-water dispersion, and removing the organic solvent from the resultant dispersion to prepare a water dispersion. The kneading and dispersing treatment can be performed using a ball mill, a roll mill, a beads mill, a high-pressure homogenizer, a high-speed stirring disperser, or the like.

The neutralizing agent is preferably a tertiary amine such as ethylamine, trimethylamine, or the like, lithium hydroxide, sodium hydroxide, potassium hydroxide, ammonia, or the like, and the resultant water dispersion preferably has a pH of 6 to 10.

The water-insoluble polymer for coating preferably has a weight-average molecular weight of about 10,000 to 150,000 from the viewpoint of stable dispersion of the pigment. The weight-average molecular weight can be measured by a molecular weight analysis method using gel permeation chromatography (GPC).

In the ink composition of the present invention, a self-dispersible pigment can be used. The “self-dispersible pigment” represents a pigment which contains a large number of hydrophilic functional groups and/or salts thereof (hereinafter referred to as “dispersibility-imparting groups”) bonded to the surface directly or through an alkyl group, an alkyl ether group, an aryl group, or the like, so that the pigment can be dispersed and/or dissolved in an aqueous medium without a dispersant. The expression “dispersed and/or dissolved in an aqueous medium without a dispersant” represents a state in which the pigment is stably present with the dispersible minimum particle diameter in an aqueous medium without using a dispersant for dispersing the pigment. The “minimum dispersible particle diameter” represents a pigment particle diameter which does not decrease any further even by increasing the dispersion time.

An ink containing the self-dispersible pigment as a coloring agent can be easily prepared so as to have substantially no foaming or the like due to the dispersant and excellent ejection stability because the dispersant for dispersing a usual pigment need not be contained. In addition, since a significant increase in viscosity due to the dispersant can be suppressed, a larger number of pigments can be contained, and thus a print density can be sufficiently increased, thereby causing easy handleability.

The self-dispersible pigment can be produced by, for example, a physical treatment or chemical treatment of a pigment, in which a dispersibility-imparting group or an active species having the dispersibility-imparting group, such as —COON, —CO, —OH, —SO₃H, —PO₃H₂, quaternary ammonium, or a salt thereof, is bonded (grafted) to the surface of the pigment. Examples of the physical treatment include a vacuum plasma treatment and the like. Examples of the chemical treatment include a wet oxidization method of oxidizing the pigment surface with an oxidizing agent in water, a method of bonding a carboxyl group through a phenyl group by bonding p-aminobenzoic acid to the pigment surface, and the like.

In this embodiment, the self-dispersible pigment which is surface-treated by oxidation with a hypohalous acid and/or hypohalite or oxidation with ozone is preferred from the viewpoint of high color development.

The self-dispersible pigment preferably has a volume-average particle diameter of 50 to 250 nm from the viewpoint of dispersion stability in the ink composition, higher OD value of a recorded image, and further improvement in glossiness. The volume-average particle diameter can be determined by particle size measurement with Microtrac UPA150 (manufactured by Microtrac Co., Ltd.), a particle size distribution analyzer LPA 3100 (manufactured by Otsuka Electronic Co.), or the like.

As the pigment used for the self-dispersible pigment, any one of the above-described coloring agents, inorganic pigments, and organic pigments can be used.

A commercial pigment can be used as the self-dispersible pigment. Examples thereof include Microjet CW-1 (trade name; manufactured by Orient Chemical Industries, Ltd.), CAB-O-JET200, CAB-O-JET250C, CAB-O-JET260M, CAB-O-JET270Y, and CAB-O-JET300 (trade name; manufactured by Cabot Corporation), and the like.

These pigments are preferably added in an amount of 6% by mass or more in terms of solid content from the viewpoint of achieving a sufficient print density on plain paper.

The ink composition of the present invention contains an unsaturated fatty acid from the viewpoint of improvement in ejection stability and intermittent performance.

By adding the unsaturated fatty acid to the ink composition, dispersion of the solid content in the ink composition is stabilized, thereby decreasing thixotropy. In addition, adhesion of a resin or the like to the orifices, which is a cause of non-ejection of ink, clogging, the like, is suppressed by adding the unsaturated fatty acid to the ink composition.

The content of the unsaturated fatty acid is preferably 0.08% to 3% by mass. When the content is less than 0.08% by Mass; a sufficient effect cannot be obtained, while when the content is 3% by mass or more, the problem with storage stability of the ink composition, attack on a head and an ink system, and the like occurs.

Examples of the unsaturated fatty acid include lauroleic acid, myristoleic acid, oleic acid, linoleic acid, linolenic acid, dodecynoic acid, octadecynoic acid, crotonic acid, palmitoleic acid, elaidic acid, vaccenic acid, gadoleic acid, eicosenoic acid, erucic acid, nervonic acid, eicosadienoic acid, docosadienoic acid, pinolenic acid, eleostearic acid, mead acid, eicosatrienoic acid, stearidonic acid, arachidonic acid, eicosatetraenoic acid, adrenic acid, bosseopentaenoic acid, eicosapentaenoic acid, osbond acid, clupanodonic acid, tetracosapentaenoic acid, docosahexaenoic acid, nisinic acid, and the like. The unsaturated fatty acid is preferably oleic acid.

The ink composition of the present invention contains an alkyl alcohol having 1 to 4 carbon atoms from the viewpoint of improvement in solubility of the unsaturated fatty acid and improvement in storage stability of the ink composition.

Examples of the alkyl alcohol having 1 to 4 carbon atoms include ethanol, methanol, butanol, propanol, isopropanol, and the like.

The alkyl alcohol having 1 to 4 carbon atoms is preferably contained at 0.5% to 5% by mass.

The ink composition of the present invention contains 15% by mass or more of a polyhydric alcohol monoalkyl ether having a vapor pressure of 0.1 mmHg or less at 20° C. and/or a nitrogen-containing cyclic compound and a polyhydric alcohol from the viewpoint of securing print quality of an ink jet printer, ejection stability, and reliability for anti-clogging of nozzles, and the like.

Examples of the polyhydric alcohol monoalkyl ether having a vapor pressure of 0.1 mmHg or less at 20° C. include diethylene glycol monoethyl ether, diethylene glycol monobutyl ether, diethylene glycol monoisobutyl ether, dipropylene glycol monomethyl ether, dipropylene glycol monoisopropyl ether, dipropylene glycol monoisopropyl ether, dipropylene glycol monobutyl ether, triethylene glycol monomethyl ether, triethylene glycol monobutyl ether, tripropylene glycol monomethyl ether, tripropylene glycol monobutyl ether, and the like.

Examples of the nitrogen-containing cyclic compound include 1,3-dimethyl-2-imidazolidinone, 2-pyrrolidone, N-methyl-2-pyrrolidone, and the like.

Examples of the polyhydric alcohol include glycerin, 1,2,6-hexanetriol, trimethylolpropane, ethylene glycol, propylene glycol, diethylene glycol, triethylene glycol; tetraethylene glycol, pentaethylene glycol, dipropylene glycol, 2′-butene-1,4-diol, 2-ethyl-1,3-hexanediol, 2-methyl-2,4-pentanediol, 1,2-octanediol, 1,2-hexanediol, 1,2-pentanediol, 1,5-pentanediol, 4-methyl-1,2-pentanediol, and the like.

The ink composition of the present invention contains a surfactant, in addition to the unsaturated fatty acid, from the viewpoint of storage stability. As the surfactant, an anionic surfactant, a cationic surfactant, an amphoteric surfactant, or a nonionic surfactant can be contained. In particular, the nonionic surfactant is preferred from the viewpoint of the ink composition having little foaming and frothing.

Specific examples of the nonionic surfactant include acetylene glycol surfactants; acetylene alcohol surfactants; ether surfactants such as polyoxyethylene nonylphenyl ether, polyoxyethylene octylphenyl ether, polyoxyethylene dodecylphenyl ether, polyoxyethylene alkylallyl ethers, polyoxyethylene oleyl ether, polyoxyethylene lauryl ether, polyoxyethylene alkyl ethers, polyoxyalkylene alkyl ethers, and the like; ester surfactants such as polyoxyethylene oleic acid, polyoxyethylene oleate, polyoxyethylene distearate, sorbitan laurate, sorbitan monostearate, sorbitan monooleate, sorbitan sesquioleate, polyoxyethylene monooleate, polyoxyethylene stearate, and the like; polyether-modified siloxane surfactants such as dimethyl polysiloxane and the like; other fluorine-containing surfactants such as fluoroalkyl esters, perfluoroalkyl carboxylates, and the like. These nonionic surfactants can be used alone or in combination of two or more.

Among these nonionic surfactants, in particular, acetylene glycol surfactants and/or polyether-modified siloxane surfactants are preferred in view of little foaming and excellent defoaming performance.

Further specific examples of the acetylene glycol surfactants include 2,4,7,9-tetramethyl-5-decyne-4,7-diol, 3,6-dimethyl-4-octyne-3,6-diol, 3,5-dimethyl-1-hexyne-3-ol, and the like. However, commercially available nonionic surfactants may be used. Examples of commercial nonionic surfactants include Surfynol (registered trade name) 104, 82, 465, 485, and TG manufactured by Air Products and Chemicals, Inc., Olfine (registered trade name) STG and Olfine E1010 manufactured by Nissin Chemical Industry Co., Ltd., and the like. Further specific examples of the polyether-modified siloxane surfactants include BYK-345, BYK-346, BYK-347, BYK-348, and UV3530 of 3YK Chemie Japan, Inc., and the like. A plurality of types of surfactants may be used, the surface tension is preferably adjusted to 20 to 40 mN/m, and the content in the ink composition is 0.1% to 3.0% by mass.

The ink composition of the present invention preferably contains a resin emulsion form the viewpoint of enhancing dispersion stability of the pigment and the viewpoint of securing fixability to a recorded matter.

The resin emulsion preferably include a mixture of resin fine particles having a minimum film-forming temperature of 20° C. or more and resin fine particles having a minimum film-forming temperature of less than 20° C. By using, as the resin emulsion, a mixture of resin fine particles having a minimum film-forming temperature of 20° C. or more and resin fine particles having a minimum film-forming temperature of less than 20° C., the resin fine particles having a minimum film-forming temperature of 20° C. or more forms a film at an ambient temperature and thus improve fixability and abrasion resistance, and the resin fine particles having a minimum film-forming temperature of less than 20° C. does not form a film at an ambient temperature and remain as particles on paper, thereby realizing high color development on plain paper and regenerated paper by the function to allow pigment particles to be further present on a paper surface.

The resin emulsion preferably includes at least one selected from the group consisting of an acrylic resin, a methacrylic resin, a vinyl acetate resin, a vinyl chloride resin, and a styrene-acrylic resin. These resins may be used as a homopolymer or a copolymer, and any one of a single-phase structure or a multi-phase structure (core-shell type) may be used.

Further, at least any one of the two or more resin emulsions used in the ink composition of the present invention is preferably mixed in the ink composition in the form of a resin fine particle emulsion produced by emulsion polymerization of unsaturated monomers. The reason for this is that when resin fine particles are added directly to the ink composition, the resin fine particles may not be sufficiently dispersed, and thus the emulsion form is preferred in view of production of the ink composition. In addition, the emulsion is preferably an acryl emulsion from the viewpoint of storage stability of the ink composition.

The emulsion (acryl emulsion or the like) of resin fine particles can be prepared by a known emulsion polymerization method. For example, the emulsion can be prepared by emulsion polymerization of an unsaturated monomer (an unsaturated vinyl monomer or the like) in the presence of a polymerization initiator and a surfactant in water.

Examples of the unsaturated monomer include monomers generally used in emulsion polymerization, such as acrylate monomers, methacrylate monomers, aromatic vinyl monomers, vinyl ester monomers, vinyl cyanide monomers, halogenated monomers, olefin monomers, diene monomers, and the like. Further specific examples include acrylates such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, decyl acrylate, dodecyl acrylate, octadecyl acrylate, cyclohexyl acrylate, phenyl acrylate, benzyl acrylate, glycidyl acrylate, and the like; methacrylates such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, glycidyl methacrylate, and the like; vinyl esters such as vinyl acetate and the like; vinyl cyanides such as acrylonitrile, methacrylonitrile, and the like; halide monomers such as vinylidene chloride, vinyl chloride, and the like; aromatic vinyl monomers such as styrene, α-methylstyrene, vinyltoluene, 4-tert-butylstyrene, chlorostyrene, vinylanisole, vinylnaphthalene, and the like; olefins such as ethylene, propylene, and the like; dienes such as butadiene, chloroprene, and the like; vinyl monomers such as vinyl ether, vinyl ketone, vinyl pyrrolidone, and the like; unsaturated carboxylic acids such as acrylic acid, methacrylic acid, itaconic acid, fumaric acid, maleic acid, and the like; acrylamides such as acrylamide, methacrylamide, N,N′-dimethylacrylamide, and the like; and hydroxyl group-containing monomers such as 2-hydroxyethyl acrylate, 2-hydroxypropyl acrylate, 2-hydroxyethyl methacrylate, 2-hydroxypropyl methacrylate, and the like. These may be used alone or as a mixture of two or more.

In addition, a crosslinking monomer having two or more polymerizable double bonds can also be used. Examples of the crosslinking monomer having two or more polymerizable double bonds include diacrylate compounds such as polyethylene glycol diacrylate, triethylene glycol diacrylate, 1,3-butylene glycol diacrylate, 1,4-butylene glycol diacrylate, 1,6-hexanediol diacrylate, neopentyl glycol diacrylate, 1,9-nonanediol diacrylate, polypropylene glycol diacrylate, 2,2′-bis(4-acryloxypropyloxyphenyl)propane, 2,21-bis(4-acryloxydiethoxyphenyl)propane, and the like; triacrylate compounds such as trimethylolpropane triacrylate, trimethylolethane triacrylate, tetramethylolmethane triacrylate, and the like; tetraacrylate compounds such as ditrimethylol tetraacrylate, tetramethylolmethane tetraacrylate, pentaerythritol tetraacrylate, and the like; hexaacrylate compounds such as dipentaerythritol hexaacrylate and the like; dimethacrylate compounds such as ethylene glycol dimethacrylate, diethylene glycol dimethacrylate, triethylene glycol dimethacrylate, polyethylene glycol dimethacrylate, 1,3-butylene glycol dimethacrylate, 1,4-butylene glycol dimethacrylate, 1,6-hexanediol dimethacrylate, neopentyl glycol dimethacrylate, dipropylene glycol dimethacrylate, polypropylene glycol dimethacrylate, polybutylene glycol dimethacrylate, 2,2′-bis(4-methacryloxydiethoxyphenyl)propane, and the like; trimethacrylate compounds such as trimethylolpropane trimethacrylate, trimethylolethane trimethacrylate, and the like; methylene bisacrylamide; divinylbenzene; and the like. These can be used alone or as a mixture of two or more.

Besides the polymerization initiator and the surfactant used in emulsion polymerization, a chain transfer agent, a neutralizing agent, and the like may be further used according to a usual method. In particular, as the neutralizing agent, ammonia or an inorganic alkali hydroxide, e.g., sodium hydroxide, potassium hydroxide, or the like, is preferred.

In the present invention, the resin emulsion is preferably contained in the ink composition within a range of 1 to 10% by mass from the viewpoint of more effectively achieving ink jet proper physical values, reliability (clogging, ejection stability, and the like), high OD value, fixability, glossiness, and the like of the ink composition.

On the other hand, the volume-average particle diameter of the resin emulsion used in the ink composition is preferably 20 to 200 nm from the viewpoint of further improving dispersion stability in the ink composition, a OD value of a recorded image, and glossiness.

A pH adjustor can be added to the ink composition of the present invention. As the pH adjustor, an alkali hydroxide such as lithium hydroxide, potassium hydroxide, sodium hydroxide, or the like and/or ammonia or alkanolamine such as triethanolamine, tripropanolamine, diethanolamine, monoethanolamine, or the like can be used. In particular, the ink composition preferably contains at least one pH adjustor selected from alkali metal hydroxides, ammonia, triethanolamine, and tripropanolamine and is adjusted to pH 6 to 10. Within this pH range, the constituent materials and the like of an ink jet printer are not changed in quality, and recoverability of clogging is maintained.

If required, collidine, imidazole, phosphoric acid, 3-(N-morpholino)propanesulfonic acid, tris(hydroxymethyl)aminomethane, boric acid, or the like can be used as a pH buffer.

The trialkanolamine can be preferably used as a gloss-imparting agent for the ink composition and can be added to the yellow, magenta, and cyan ink compositions in order to form an image with uniform gloss on a glossy recording medium.

When the trialkanolamine is used as the gloss-imparting agent of the ink composition, the content is preferably 10 to 50% by mass, more preferably 12 to 45% by mass, based on 100% by mass of the pigment, and preferably 1% by mass or more, more preferably 1% by mass as a lower limit to 3% by mass as an upper limit, based on the total amount of the ink composition.

The trialkanolamine is not particularly limited but is preferably triethanolamine and/or tripropanolamine from the viewpoint of improvement in print stability and glossiness.

Further, if required, a defoaming agent, an antioxidant, an ultraviolet absorber, a preservative/fungicidal agent, and the like can be added to each of the ink compositions used in the present invention.

Examples of the antioxidant and the ultraviolet absorber include allophanates such as allophanate, methyl allophanate, and the like; biurets such as biuret, dimethyl biuret, tetramethyl biuret, and the like; L-ascorbic acid and salts thereof; Tinuvin 328, 900, 1130, 384, 292, 123, 144, 622, 770, and 292, Irgacor 252 and 153, Irganox 1010, 1076, and 1035, and MD1024 which are manufactured by Ciba-Geigy Corporation; lanthanide oxides; and the like.

Examples of the preservative/fungicidal agent include sodium benzoate, sodium pentachlorophenol, sodium 2-pyridinethiol-1-oxide, sodium sorbate, sodium dehydroacetate, 1,2-dibenzisothiazolin-3-one (Proxel CRL, Proxel BDN, Proxel GXL, Proxel XL-2, and Proxel TN manufactured by Avecia Inc.), and the like.

The ink composition of the present invention can be prepared by the same method as for usual ink compositions with a usual known device, for example, a ball mill, a sand mill, an attritor, a basket mill, a roll mill, or the like. In preparation, preferably, coarse particles are removed from the viewpoint of preventing nozzle clogging. The coarse particles are removed by filtering an ink, which is produced by mixing the components, through a filter such as a membrane filter, a mesh filter, or the like in order to remove particles of preferably 10 μm or more, more preferably 5 μm or more.

As the water contained in the ink composition of the present invention, pure water or ultrapure water such as ion-exchanged water, ultrafiltrated water, Milli-Q water, distilled water, or the like is preferably used. In particular, water sterilized with ultraviolet irradiation or addition of hydrogen peroxide, or the like is preferably used from the viewpoint of enabling long-term storage of the ink composition by preventing the occurrence of fungi and bacteria.

When the water content is less than 10% by mass, fixability to a recording medium may deteriorate. On the other hand, when the water content exceeds 60% by mass, like in a usual aqueous ink composition, cockling or curling easily occurs during printing on a recording medium including an absorption layer having a paper support with low ink absorbency.

When the water content in the ink composition is specified to fall in the above-described range, the amount of water absorbed by cellulose in coated paper is smaller than that of a usual ink composition, and consequently swelling of cellulose, which is considered to cause cockling or curling, can be suppressed. Therefore, the ink composition of the present invention is useful for media having low ink absorbency, such as plain paper, coated paper for printing (printing sheet), and the like.

In the present invention, “plain paper” refers to paper composed of pulp as a raw material and used for a printer and the like, and is defined by JIS P 0001 No. 6139. Specific examples of the plain paper include wood free paper, PPC copy paper, uncoated printing paper, and the like. As the plain paper, commercial paper available from various companies can be used, and for example, various types such as Xerox 4200 (manufactured by Xerox Corporation), GeoCycle (manufactured by Georgia-Pacific Corporation), and the like can be used.

In addition, in the present invention, any desired coated paper for printing (referred to as “printing paper”) generally used as print paper for relief printing, surface printing (e.g., offset printing), or intaglio printing (e.g., gravure printing) can be used. The coated paper for printing includes normal coated paper, cast coated paper, and matte coated paper. The coated paper also includes printing paper defined in JIS P 0001 No. 6122, coated paper (e.g., OK Topcoat N) defined in JIS P 0001 No, 6059, and the like.

### Ink Jet Recording Method

The ink composition of the present invention can be preferably used for writing instruments such as pens, stamps, and the like, but can also be preferably used as an ink composition recorded on a recording medium by an ink jet recording method. In an embodiment of the present invention, an ink jet recording system refers to a system in which an ink composition is ejected as droplets from fine nozzles, and the droplets are adhered to a recording medium by an ink jet recording apparatus. Detailed description is given below.

A first method is an electrostatic suction method in which an ink is continuously ejected in the form of droplets from nozzles by applying a strong electric field between the nozzles and an acceleration electrode disposed in front of the nozzles and supplying a print information signal to deflection electrodes during the time the ink droplets fly between the deflection electrodes, or ejecting ink droplets according to a print information signal without deflecting the ink droplets.

A second method is a type in which ink droplets are forcibly ejected by applying pressure to an ink liquid with a small pump and mechanically vibrating nozzles with a crystal oscillator. The ejected ink droplets are electrically charged simultaneously with ejection, and a print information signal is supplied to deflection electrodes during the time the ink droplets fly between the deflection electrodes.

A third method is a type that uses piezoelectric elements in which ink droplets are ejected for recording by applying pressure to an ink liquid with the piezoelectric elements simultaneously with application of a print information signal.

A fourth method is a type in which the volume of an ink liquid is expanded rapidly by the action of thermal energy, and ink droplets are ejected for printing by foaming the ink liquid by heating with a microelectrode according to a print information signal.

Any one of these methods can be used as an ink jet recording method using the ink composition of the present invention.

According to the ink jet recording method of the present invention, the use of the above-described ink composition can realize excellent curling properties and high color development for media having low water absorbency, such as plain paper, coated paper, and the like, and can improve ejection stability of a pigment ink with a high solid content.

### Recorded Matter

A recorded matter of the present invention is at least that obtained by recording on a recording medium using the ink composition described above. By using the above-described ink composition, the recorded matter can realize excellent curling properties and high color development for media having low water absorbency, such as plain paper, coated paper, and the like.

### EXAMPLES

### 1. Preparation of Pigment Dispersion Solution

### (1) Preparation of Black Pigment Dispersion Solution B1 (Self-Dispersible Pigment)

First, 100 g of commercial carbon block 5170 (trade name, manufactured by Degussa Co., Ltd.) was mixed with 500 g of water, followed by grinding with zirconia beads in a ball mill. To the resultant ground mother solution, 500 g of sodium hypochlorite (effective chlorine concentration 12%) was added dropwise, followed by wet oxidation by boiling for 10 hours under stirring. The resultant dispersion mother solution was filtered with glass fiber filter paper GA-100 (trade name, manufactured by Advantec Toyo Co., Ltd.), and further washed with water. The resulting wet cake was again dispersed in 5 kg of water, desalted and purified by a reverse osmosis membrane until electric conductivity was 2 mS/cm, and further concentrated to a pigment concentration of 25% by mass to prepare a self-dispersible pigment solution B1 containing self-dispersible pigment as dispersed particles.

### (2) Preparation of Magenta Pigment Dispersion Solution M1 (Water-Insoluble Polymer-Coated Pigment)

First, a water-insoluble polymer was synthesized according to the procedures below. In a reactor sufficiently displaced with nitrogen gas, 20 parts by mass of an organic solvent (methyl ethyl ketone), 0.03 part by mass of a polymerization chain transfer agent (2-mercaptoethanol), a polymerization initiator, the monomers shown in Table 1 were placed and polymerized at 75° C. under stirring. Then, a solution of 0.9 part by mass of 2,2′-azobis(2,4-dimethylvaleronitrile) in 40 parts by mass of methyl ethyl ketone was added relative to 100 parts by mass of the monomer component, and the resultant mixture was aged at 80° C. for 1 hour to prepare a polymer solution. In Table 1, each numerical value represents a ratio (% by mass) of each monomer based on the total (1000) of a monomer mixture.

TABLE 1

| | Water-insoluble polymer |
|---|---|
| Composition of monomer mixture | (% by weight) |
| Polypropylene glycol monomethacrylate | 15 |
| (PO = 9) | |
| Poly(ethylene glycol-propylene glycol) | 15 |
| monomethacrylate (EO = 5, PO = 7) | |
| Methacrylic acid | 12 |
| Styrene monomer | 40 |
| Styrene macromer | 15 |
| Benzyl methacrylate | 10 |

EO . . . ethylene oxide
PO . . . propylene oxide

Next, a magenta pigment dispersion solution M1 was prepared using the resultant water-insoluble polymer according to the procedures below. First, 5 parts by mass of the water-insoluble polymer shown in Table 1 was dissolved in 45 parts by mass of methyl ethyl ketone, and a salt-forming group was neutralized by adding a predetermined amount of a 20% aqueous sodium hydroxide solution (neutralizing agent) to the mixture. Further, 20 parts by mass of C. I. Pigment Violet 19 was added as a pigment to the mixture, followed by kneading for 2 hours with a beads mill. Then, 120 parts by mass of ion-exchanged water was added to the resultant kneaded product, followed by stirring. Then, methyl ethyl ketone was removed at 60° C. under reduced pressure, and water was partially removed to prepare a pigment dispersion solution, M1 with a solid content of 25% by mass.

### 2. Preparation of Ink Composition

An ink composition was prepared by combining a pigment, a polyhydric alcohol having a vapor pressure of 0.1 mmHg or less at 20° C. and/or a nitrogen-containing cyclic compound, a polyhydric alcohol, an unsaturated fatty acid, an alkyl alcohol having 1 to 4 carbon atoms, a resin emulsion, a surfactant, and water as shown in Table 2. “Balance” of ion-exchanged water represents that ion-exchanged water is added so that a total amount of ink is 100 parts.

TABLE 2

| | | Example | | | | | | | Comparative Example | | |
|---|---|---|---|---|---|---|---|---|---|---|---|
| Ink composition | | 1 | 2 | 3 | 4 | 5 | 6 | 7 | 1 | 2 | 3 |
| Pigment | B1 | 36 | 36 | 20 | 36 | 36 | 0 | 0 | 36 | 0 | 36 |
| dispersion | M1 | 0 | 0 | 0 | 0 | 0 | 36 | 36 | 0 | 36 | 0 |
| (solid | | | | | | | | | | | |
| content = 25 wt | | | | | | | | | | | |
| %) | | | | | | | | | | | |
| Polyhydric | TEGmBE | 20 | 22 | 23 | 20 | 23 | 18 | 20 | 23 | 15 | 20 |
| alcohol | 2- | 0 | 3 | 0 | 0 | 0 | 2 | 0 | 0 | 0 | 2 |
| monoalkyl | pyrrolidone | | | | | | | | | | |
| ether and/or | | | | | | | | | | | |
| nitrogen- | | | | | | | | | | | |
| containing | | | | | | | | | | | |
| solvent | | | | | | | | | | | |
| Polyhydric | 1,2-HD | 5 | 5 | 5 | 5 | 5 | 5 | 5 | 5 | 3 | 5 |
| alcohol | | | | | | | | | | | |
| Unsaturated | Oleic acid | 2.0 | 0.2 | 2.0 | 3.8 | 0.0 | 2.8 | 5.0 | 0.0 | 2.0 | 3.0 |
| fatty acid | Palmitoleic | 0 | 0 | 0 | 0 | 2 | 0 | 0 | 0 | 0 | 0 |
| | acid | | | | | | | | | | |
| Alkyl alcohol | Ethanol | 1 | 1 | 1 | 1 | 1 | 1 | 1 | 1 | 1 | 0 |
| having 1 to 4 | | | | | | | | | | | |
| carbon atoms | | | | | | | | | | | |
| Surfactant | Surfynol 104 | 0.25 | 0.25 | 0.25 | 0.25 | 0.25 | 0.25 | 0.25 | 0.25 | 0.25 | 0.25 |
| | BYK348 | 0.25 | 0.25 | 0.25 | 0.25 | 0.25 | 0.25 | 0.25 | 0.25 | 0.25 | 0.25 |
| Resin | MFT = less | 2.5 | 0.0 | 2.5 | 2.5 | 2.5 | 2.5 | 2.5 | 2.5 | 2.5 | 2.5 |
| emulsion | than 20° C. | | | | | | | | | | |
| | MFT = 20° C. or | 1 | 0 | 1 | 1 | 1 | 1 | 1 | 1 | 1 | 1 |
| | more | | | | | | | | | | |

| | | | | | | | | | | |
|---|---|---|---|---|---|---|---|---|---|---|
| Ion-exchange water | Balance | Balance | Balance | Balance | Balance | Balance | Balance | Balance | Balance | Balance |
| Water content in ink | 59.0 | 59.3 | 55.0 | 57.2 | 56.0 | 58.2 | 56.0 | 58.0 | 66.0 | 57.0 |

TEGmBE . . . triethylene glycol monobutyl ether,
1,2-HD . . . 1,2-hexane diol
Surfynol 104 . . . manufactured by Air Products and Chemicals, Inc.
BYK348 . . . manufactured by BYK Chemie Japan, Inc.

As the resin emulsion, a mixture of resin fine particles having a minimum film-forming temperature (hereinafter referred to as “MFT”) of less than 20° C. and resin fine particles having a MFT of 20° C. or more was used.

The resin fine articles having a MFT of less than 20° C. were produced by polymerizing 20 g of acrylamine, 600 g of methyl methacrylate, 125 g of butyl acrylate, 30 g of methacrylic acid, and 5 g of triethylene glycol diacrylate. The resultant resin fine particles were confirmed not to form a film at a temperature of 20° C.

The resin fine articles having a MFT of 20° C. or more were produced by polymerizing 20 g of acrylamine, 130 g, of styrene, 780 g of 2-ethylhexyl acrylate, 30 g of methacrylic acid, and 2 g of triethylene glycol dimethacrylate. The resultant resin fine particles were confirmed to form a film at a temperature of 20° C.

### 3. Evaluation Test

### (1) Evaluation of Intermittent Performance

Ink jet printer PX-A550 (manufactured by Seiko Epson Corporation) was filled with each of the ink compositions (Examples 1 to 7 and Comparative Examples 1 and 2) shown in Table 2, and a carriage was scanned under a condition in which ejection was not performed for a predetermined time. Then, 20 droplets were printed on an ink jet glossy film from each nozzle, and then a recovery operation (purging with 50 droplets) was performed. The series of operations for evaluation was repeated 10 times.

Among the 20 print droplets, an enlarge photograph of the first dot was taken in the dot ejection direction and evaluated. The criteria were as follows. The results are shown in Table 3.

A: Dots of a normal size were arrayed in a line without disturbance in the ejection direction.

B: Slightly smaller dots were arrayed substantially in a line without disturbance in the ejection direction or slight disturbance occurred in the ejection direction without reaching the second line.

C: The first dot line reached beyond the second dot line or no-ejection occurred.

### (2) Storage Stability

For the ink compositions (Examples 1 to 7 and Comparative Examples 1 and 2) shown in Table 2, the physical properties after allowing to stand at 70° C. for 60 days were compared with the initial physical properties of the ink compositions. In addition, printing was performed with ink jet printer PX-A550 (manufactured by Seiko Epson Corporation) filled with each of the inks. The criteria were as follows. The results are shown in Table 3.

A: No change occurred in the physical properties or a change occurred with no problem of print quality.

B: A change in physical properties occurred with slight influence on print quality.

C: A change in physical properties occurred with significant influence on print quality.

### (3) Evaluation of Optical Density (OD Value)

Ink jet printer PX-A550 (manufactured by Seiko Epson Corporation) was filled with each of the ink compositions (Examples 1 to 7 and Comparative Examples 1 and 2) shown in Table 2, and a patch pattern with 100% duty was printed on a recording medium. As the recording medium, OK Topcoat N (manufactured by Oji Paper Co., Ltd.) as a type of printing paper (printing coated paper), Xerox P and Xerox 4024 (manufactured by Fuji Xerox Co., Ltd.) as a type of plain paper were used. In addition, the resultant patch pattern was used as a sample for each of the evaluation tests described below.

The OD value of a patch portion was measured with a Gretag densitometer (manufactured by Gretag Macbeth Co., Ltd.). An average value of each sample was calculated, and an optical density value (OD value) was evaluated based on the calculated average OD value according to the criteria described below. The results are shown in Table 3.

A: 1.2 or more

B: 1.0 or more and less than 1.2

C: Less than 1.0

### (4) Evaluation of Cockling

Irregularities (cockling) of each of the samples formed according to the procedures described in (3) were measured with a laser displacement meter (LK-010, manufactured by Keyence Corporation). An average value of each sample was calculated, and cockling was evaluated based on the calculated average value according to the criteria described below. The results are shown in Table 3.

A: Irregularities of less than 1.0 mm

B: irregularities of 1.0 mm or more and less than 2.0 mm

C: Irregularities of 2.0 mm or more

### (5) Evaluation of Curling

Curling of each of the samples formed according to the procedures described in (3) was evaluated by measuring the height from the bottom to the top of a curl. An average value of each sample was calculated, and curling was evaluated based on the calculated average value according to the criteria described below. The results are shown in Table 3.

A: Less than 1.0 cm

B: 1.0 cm or more and less than 3.0 cm

C: 3.0 cm or more

### (6) Fixability (Drying Property)

Each of the samples after printing according to the procedures described in (3) was naturally dried over day and night and then a print portion of each sample was rubbed with a finger. The conditions of a print surface and the ink adhering to the finger were visually observed. The results were evaluated based on the criteria described below. The results are shown in Table 3.

A: Neither change in the print surface nor adhesion of ink to the finger was observed.

B: The ink was slightly rubbed off from the print surface but no adhesion of ink to the finger was observed.

C: The ink was rubbed off from the print surface and adhesion of ink to the finger was observed.

TABLE 3

| | | | | | | | | Comparative | | |
|---|---|---|---|---|---|---|---|---|---|---|
| Evaluation | Example | | | | | | | Example | | |
| item | 1 | 2 | 3 | 4 | 5 | 6 | 7 | 1 | 2 | 3 |
| Intermittent | A | B | A | A | B | A | A | C | A | C |
| performance | | | | | | | | | | |
| Storage | A | A | A | B | A | A | B | A | A | C |
| stability | | | | | | | | | | |
| Optical | A | A | B | A | A | A | A | A | A | A |
| density (OD | | | | | | | | | | |
| value) | | | | | | | | | | |
| Cockling | A | A | A | A | A | A | A | A | C | A |
| Curling | A | A | A | A | A | A | A | A | C | A |
| Fixability | A | B | A | A | A | A | A | A | A | A |

What is claimed is:

1. An ink composition comprising at least a pigment, a polyhydric alcohol monoalkyl ether having a vapor pressure of 0.1 mmHg or less at 20° C. and/or a nitrogen-containing cyclic compound, a polyhydric alcohol, an unsaturated fatty acid, an alkyl alcohol having 1 to 4 carbon atoms, a surfactant, and 10% to 60% by mass of water.

2. The ink composition according to claim 1, wherein the content of the unsaturated fatty acid is 0.08% to 3% by mass.

3. The ink composition according to claim 1, wherein the unsaturated fatty acid is oleic acid.

4. The ink composition according to claim 1, wherein the content of the pigment is 6% by mass or more.

5. The ink composition according to claim 1, wherein the pigment is a pigment coated with a water-insoluble polymer.

6. The ink composition according to claim 1, wherein the pigment is a self-dispersible pigment.

7. The ink composition according to claim 1, wherein the surfactant is an acethylene glycol surfactant and/or a poly-modified siloxane surfactant.

8. The ink composition according to claim 1, further comprising a resin emulsion.

9. The ink composition according to claim 8, wherein the resin emulsion is a mixture of resin fine particles having a minimum film-forming temperature of 20° C. or more and resin fine particles having a minimum film-forming temperature of less than 20° C.

10. An ink jet recording method comprising printing by ejecting droplets of an ink composition and adhering the droplets to a recording medium, wherein the ink composition according to claim 1 is used.

11. An ink jet recording method comprising printing by ejecting droplets of an ink composition and adhering the droplets to a recording medium, wherein the ink composition according to claim 2 is used.

12. An ink jet recording method comprising printing by ejecting droplets of an ink composition and adhering the droplets to a recording medium, wherein the ink composition according to claim 3 is used.

13. An ink jet recording method comprising printing by ejecting droplets of an ink composition and adhering the droplets to a recording medium, wherein the ink composition according to claim 4 is used.

14. An ink jet recording method comprising printing by ejecting droplets of an ink composition and adhering the droplets to a recording medium, wherein the ink composition according to claim 5 is used.

15. An ink jet recording method comprising printing by ejecting droplets of an ink composition and adhering the droplets to a recording medium, wherein the ink composition according to claim 6 is used.

16. An ink jet recording method comprising printing by ejecting droplets of an ink composition and adhering the droplets to a recording medium, wherein the ink composition according to claim 7 is used.

17. An ink jet recording method comprising printing by ejecting droplets of an ink composition and adhering the droplets to a recording medium, wherein the ink composition according to claim 8 is used.

18. An ink jet recording method comprising printing by ejecting droplets of an ink composition and adhering the droplets to a recording medium, wherein the ink composition according to claim 9 is used.

19. A recorded matter recorded by the ink jet recording method according to claim 10.
